(19) United States
(12) Patent Application Publication
(10) Pub. No.: US 2025/0251894 A1
(43) Pub. Date: Aug. 7, 2025

(54) EXTERIOR VEHICLE SCREENS ELECTRONIC COLOR TRANSFORMATION FOR VEHICLES

(71) Applicant: KING FAISAL UNIVERSITY, AL-AHSA (SA)

(72) Inventors: MAMDOUH MOSAAD AHMED HELALI, AL-AHSA (SA); ROMMEL MAHMOUD ALALI, AL-AHSA (SA); MOHAMMED SAEED AL-QAHTANI, AL-AHSA (SA); MOSSAD MAMDOUH HELALI, AL-AHSA (SA); ABDELRAHMAN HAMED ELGAMAL, AL-AHSA (SA)

(21) Appl. No.: 18/433,341

(22) Filed: Feb. 5, 2024

(51) Int. Cl. G06F 3/14

(52) U.S. Cl. CPC G06F 3/1446

(57) ABSTRACT

An exterior vehicle display system includes a display attached to an exterior portion of a vehicle. A display control system is in communication with the display and determines what content to display on the display. A coating covers the display to withstand direct sunlight and resist scratches.

### BACKGROUND

### 1. Field

The present disclosure relates to vehicle entertainment and showcasing systems, and particularly exterior vehicle screens allowing users to display content on the outside of a vehicle, and colors changes for security purposes.

### 2. Description of the Related Art

The use of vehicles such as cars has changed through the years. Primarily used for transportation, it was initially a luxury and has become essential in everyday use. Once it had no roof and now it includes climate control, internet access and now all electric power. Automobiles are no longer only for transportation, but are seen as information sources where you can listen to music, podcasts, news as well as review emails, social media post etc. Information such as the closest restaurants, gas stations, electric charging stations, grocery store and almost any other type of information imaginable is available to an occupant of the vehicle.

### SUMMARY

In certain situations, automobile owners (vehicle owners) may seek color changes for security purposes or to transform their vehicles into advertising, media, or entertainment showcases in tourist destinations and parks.

The process involves enveloping the car's body with screens resembling those utilized in televisions or smart tablets. These screens are equipped with LED photocells capable of responding to a spectrum of colors and are linked to a mobile application for color control. The screens are constructed from shock-resistant materials and coated to withstand direct sunlight and resist scratches. To ensure compatibility and conformity with the car's contours, the car's body is covered with contiguous screen segments.

The process of selecting, adjusting, and coordinating colors, shapes, images, and textual content is facilitated through a dedicated mobile application. Further refinement is leveraged through artificial intelligence technology and advanced computer programs, enhancing its appeal to customers.

An exterior vehicle display system, in one embodiment, includes a display attached to an exterior portion of a vehicle. A display control system is in communication with the display and determines what content to display on the display. A coating covers the display to withstand direct sunlight and resist scratches.

The display is made from shock-resistant materials, and can include multiple screens or multiple contiguous screen segments.

The display includes LED photocells capable of responding to a spectrum of colors. The display control system can be an application on a mobile phone.

The exterior display system can further include a solar cell attached to an exterior portion of the vehicle to power the display.

The exterior display system in another embodiment can further include a solar cell attached to the display. The solar cell collects and stores energy to power the display.

An exterior display system method, includes sending information from a display control system in communication with a display; displaying the information sent from the display control system on the display attached to an exterior portion of a vehicle; and protecting the display with a coating covering the display to withstand direct sunlight and resist scratches.

The exterior display system method further includes supplying power to the display from a solar cell attached to an exterior portion of the vehicle.

The exterior display system method, in another embodiment, further includes supplying power to the display from a solar cell attached to the display.

These and other features of the present subject matter will become readily apparent upon further review of the following specification.

### BRIEF DESCRIPTION OF THE DRAWINGS

FIG. 1 is an illustration of an exterior vehicle display system displaying a message “Caution: Vehicle Theft”.

FIG. 2 is an illustration of an exterior vehicle display system having multiple display screens.

Similar reference characters denote corresponding features consistently throughout the attached drawings.

### DETAILED DESCRIPTION OF THE PREFERRED EMBODIMENTS

A method and system for automobile (i.e., vehicle) customization includes changing the color of a vehicle for security purposes or to transform the vehicles into advertising, media, or entertainment showcases in tourist destinations and parks. The process involves enveloping the car's body with display screens resembling those utilized in televisions or smart tablets. These screens are equipped with LED photocells capable of responding to a spectrum of colors and are linked to a mobile application for color control.

The screens are constructed from shock-resistant materials and coated to withstand direct sunlight and resist scratches. To ensure compatibility and conformity with the car's contours, the car's body is covered with contiguous screen segments. The work idea revolves around the utilization of a mobile application for managing photocell illumination, enabling users to select suitable colors, words, images, or shapes displayed on the screen as needed. This facilitates the alteration of the entire car's color, specific sections of the display, or the inclusion of images and shapes, as well as the presentation of relevant items or advertising phrases. Furthermore, sound effects may complement the displayed colors, images, or text on the car's exterior screen.

Certain sections of the vehicle can be outfitted with solar cells designed to capture sunlight and transform it into electrical energy. This harvested energy can be stored and subsequently employed to power the screens affixed to the car's exterior, or to operate essential components of the vehicle, including the air conditioning system or the car's engine.

The screens, in other embodiments, are distinct transparent cells that are installed on the car's body, such as logo cubes, or integrated during the manufacturing process. These transparent cells have the ability to absorb sunlight and convert it into electrical energy.

A portion of the converted electrical energy is utilized to illuminate the cells themselves, resulting in different colors based on the amount of electricity consumed. The majority of the converted electrical energy is stored for the purpose of powering the vehicle. Notably, the transparent cells possess shock-absorbing properties and can withstand various weather conditions, including rain, wind, and heat.

Furthermore, due to the transparent cells' capability to change color based on the quantity of electrical energy they receive from the stored converted energy, it becomes feasible to alter the color of the entire vehicle according to the amount of electrical energy utilized to operate these cells.

Hence, two functions of converting sunlight into electrical energy and changing the color of the car body is achieved. The following are important points:
1. The innovative solution entails the integration of specialized transparent cells within the car body or securely adhered to surface of the car body.
2. Utilization of these transparent cells to harness solar energy and convert it into electrical energy.
3. Storage of the electrical energy generated from the solar energy, facilitated by the transparent cells, in dedicated storage units.
4. Utilization of a portion of the stored electrical energy to illuminate the transparent cells, resulting in diverse colors based on the amount of electricity supplied. This offers the ability to modify the entire color of the car or specific sections of the car, following a customized program. Alternatively, cutting off the electricity supply to the transparent cells restores the car to its original color without any alteration.
5. Controlled manipulation of the electricity reaching the transparent cells to create shapes, colorful images, and text on the car's tires, implemented through a specific program. Furthermore, integration of these transparent cells with other cell types allows for additional functionalities.
6. Ultimately, the majority of the electrical energy derived from the transparent cells and stored in dedicated storage units powers the car itself. This contributes to environmental preservation by reducing pollution.

The process of selecting, adjusting, and coordinating colors, shapes, images, and textual content is facilitated through a dedicated mobile application. The present disclosure finds utility in various security scenarios, such as enabling the disguise of police vehicles for covert operations or altering the appearance of vehicles transporting valuables to deter potential thieves. Moreover, this technology can be employed in public areas, parks, and tourist destinations to serve as a medium for advertising and promoting products to a diverse customer base. It also serves as a means of raising public awareness through messages displayed on the vehicle's exterior. Furthermore, it can contribute to the harmonization of vehicle colors within specific cities, ensuring that a car adapts its color to match the chosen hue of the city it traverses, thereby blending seamlessly with other vehicles and avoiding any out-of-place appearance.

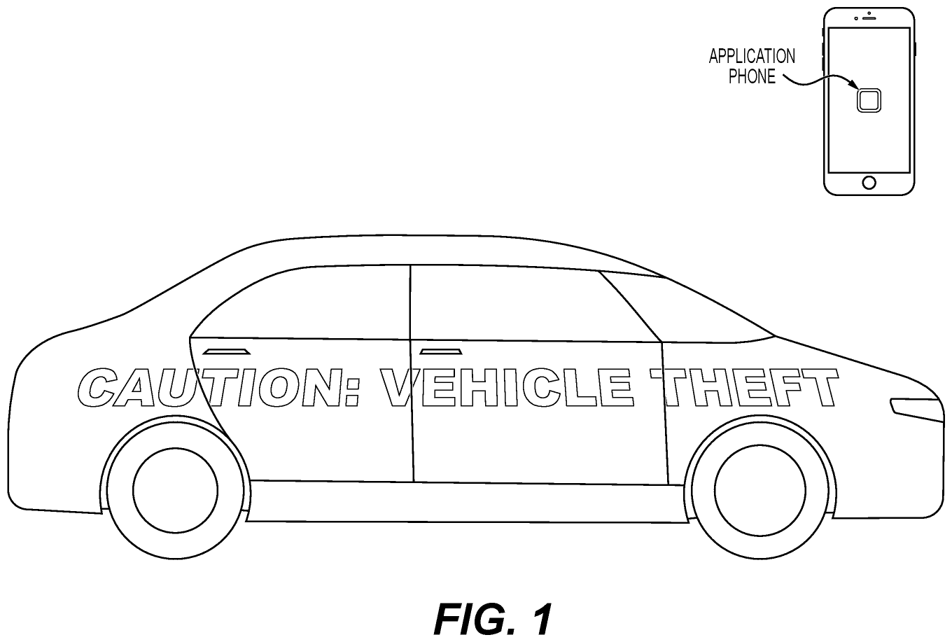

The present subject matter can also entail the use of artificial intelligence technology and advanced computer programs, enhancing its appeal to customers. These developments can also enable better control over color programming to prevent potential misuse. Additionally, fingerprint recognition technology can be integrated as an added security measure. In the event of theft or unauthorized operation, the application connected to the screen can transmit a specific code to display a warning message in an intermittent flashing format, visible to all, with the content “Caution: Vehicle Theft” as illustrated in FIG. 1.

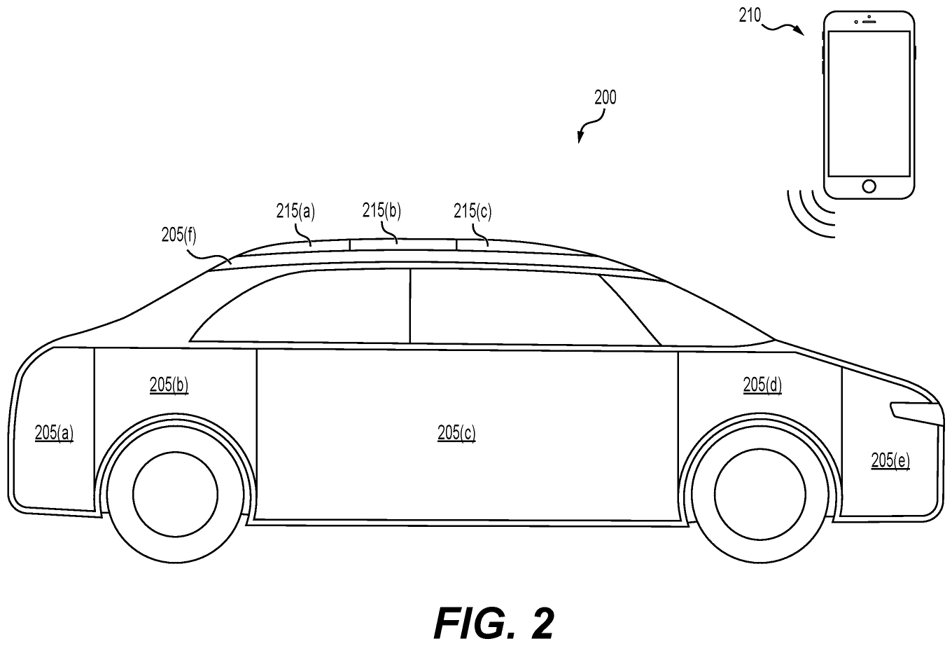

FIG. 2 is an illustration of a vehicle 200 having multiple display screens 205(a),205(b),205(c),205(d),205(e),205(f). Each of the multiple display screens 205(a),205(b),205(c),205(d),205(e),205(f) is in communication with a mobile device, such as a mobile phone 210. An app to control the screens is loaded onto the mobile phone 210. The app can control the color of the screens and can control content being displayed on the screens. As illustrated in FIG. 1, the screens can indicate if the vehicle is stolen. In other instances, if the vehicle is double parked, a message can be displayed indicating when the car will be moved and leaving a phone number in case the car needs to be moved sooner. Other options are to display advertising material for drinks, snacks or upcoming events such as concerts, musicals or plays. Sports fans can show support for their teams by displaying team symbols, colors, mascots, sayings, messages or famous quotes. An app in some embodiments may be a part of the car control system making it unnecessary to use a mobile phone 210 to control the display screens 205(a),205(b),205(c),205(d),205(e),205(f).

Solar cells 215 (a), 215 (b),215 (c) can also be positioned to capture energy from the sun. The solar cells can help power the display screens 205(a),205(b),205(c),205(d),205(e),205(f) and/or the vehicle 200. It is contemplated that the solar cells can be positioned on the screen or on the car itself.

It is to be understood that the present subject matter is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An exterior vehicle display system, comprising:
multiple displays attached to an exterior of a vehicle wherein the multiple displays are contiguous screens of various shapes and sizes enveloping a body of the vehicle across straight and curved contours of front, rear, side, and corner surfaces of the body of the vehicle, wherein the corner surfaces connect the front and side surfaces and the rear and side surfaces of the body of the vehicle;
a display control system in communication with the multiple displays and determining content to display on the multiple displays; and
a coating covering the multiple displays to withstand direct sunlight and resist scratches.

2. The exterior vehicle display system as recited in claim 1, wherein the multiple displays are made from shock-resistant materials.

3. (canceled)

4. (canceled)

5. The exterior vehicle display system as recited in claim 1, wherein the multiple displays include LED photocells capable of responding to a spectrum of colors.

6. The exterior vehicle display system as recited in claim 1, wherein the display control system is an application on a mobile phone.

7. The exterior vehicle display system as recited in claim 1, further comprising a solar cell attached to an exterior portion of the vehicle to power the multiple displays.

8. The exterior vehicle display system as recited in claim 1, further comprising a solar cell attached to the multiple displays, the solar cell storing energy to power the multiple displays.

9. An exterior vehicle display system method, comprising:
sending information from a display control system in communication with multiple displays;
displaying the information sent from the display control system on the multiple displays which are attached to an exterior portion of a vehicle and wherein the multiple displays are contiguous screens of various shapes and sizes enveloping a body of the vehicle across straight and curved contours of front, rear, side, and corner surfaces of the body of the vehicle, wherein the corner surfaces connect the front and side surfaces and the rear and side surfaces of the body of the vehicle; and
protecting the multiple displays with a coating covering the multiple displays to withstand direct sunlight and resist scratches.

10. The exterior vehicle display system method as recited in claim 9, wherein the multiple displays are made from shock-resistant materials.

11. The exterior vehicle display system method as recited in claim 9, wherein the display control system and multiple displays are configured to display a visual message indicating an unauthorized entry of the vehicle.

12. The exterior vehicle display system method as recited in claim 11, wherein the visual message indicating an unauthorized entry of the vehicle is displayed contiguously by the multiple displays.

13. The exterior vehicle display system method as recited in claim 9, wherein the multiple displays include LED photocells capable of responding to a spectrum of colors.

14. The exterior vehicle display system method as recited in claim 9, wherein the display control system is a mobile phone.

15. The exterior vehicle display system method as recited in claim 9, further comprising supplying power to the multiple displays from a solar cell attached to an exterior portion of the vehicle.

16. The exterior vehicle display system method as recited in claim 9, further comprising supplying power to the multiple displays from a solar cell attached to the multiple displays.
